(19) United States
(12) Patent Application Publication
(10) Pub. No.: US 2025/0094141 A1
(43) Pub. Date: Mar. 20, 2025

(54) METHOD FOR GENERATING A BINARY LIBRARY WITH FUNCTION TEMPLATES OR CLASS TEMPLATES THAT SUPPORT PARAMETERS OF ANY TYPE

(71) Applicant: Xiuwen DI, Taiyuan (CN)

(72) Inventor: Xiuwen DI, Taiyuan (CN)

(21) Appl. No.: 18/890,947

(22) Filed: Sep. 20, 2024

(30) Foreign Application Priority Data
Sep. 20, 2023 (CN) 202311217917.2
May 28, 2024 (CN) 202410673419.7

(51) Int. Cl. G06F 8/36

(52) U.S. Cl. CPC G06F 8/36

(57) ABSTRACT

The present disclosure relates to a field of software technology, specifically relates to a method for generating a binary library with function templates or class templates that support parameters of any type. For the above purpose, this disclosure has designed the Variant class: having the capability to represent any type data and also supports new-defined class data. It supports various operations. For source code of function or class template, just instantiated it as Variant type, and the source code can generate a binary library that supports any data type without any modifications. The binary library supports any type data and also support new-defined classes without modification. When using the binary library, ordinary data is converted into Variant objects, then passed to the binary library. The results is equivalent to those obtained from using ordinary data directly. Conversion between ordinary data and Variant objects requires only a single assignment statement.

### CROSS REFERENCE TO RELATED APPLICATIONS

This application claims foreign priority of Chinese Patent Application No. 202410673419.7, filed on May 28, 2024 and Chinese Patent Application No. 202311217917.2, filed on Sep. 20, 2023 in the China National Intellectual Property Administration, the disclosures of all of which are hereby incorporated by reference.

### TECHNICAL FIELD

The present disclosure relates to the technical field of software technology, in particular to a method for generating a binary library with function templates or class templates that support parameters of any type.

### BACKGROUND

Since the advent of template technology in C and C plus plus (C++) (which has been around for over 20 years), if you want others to use function templates or class templates with template parameters while maintaining their original functionality (i.e., accepting any type of data parameters), the only way to achieve this is by sharing the source code. However, doing so means that the author relinquishes the intellectual property rights to that code. Why not generate a binary library instead? If a binary library is generated, others cannot access the source code. The reason is that a binary library can only accept a single type of data parameter, unlike the source code, which can accept any type of data parameter.

Therefore, in C and C++ template technology, there is a need for a method that allows compiling function templates or class templates source code modules into binary libraries, while the binary library being able to accept any type of data parameters just like the source code. Through this way, the binary library can fully implement template technology (i.e., accept any type of data parameters) while also protecting the intellectual property rights of the binary library author.

The “any type of data parameters” referred to here includes: (1) the data types supported by C and C++ at the time the binary library is generated, which means the basic data types and any classes known that defined before the generation of the binary library; (2) newly introduced data types, such as new-defined classes refer to classes defined after the binary library has been generated. The source code of function templates or class templates with template parameters fully supports all of these data types.

Therefore, in order to allow the binary library to have the same function as source code of the function templates or the class templates, the binary library needs to have the following two functions:
1. the binary library supports data parameters of any basic type and parameters of known classes that defined before the generation of the binary library; and
2. after the binary library has been generated, to support parameters of new-defined classes, and without requiring modifications to the library, that is, thus ensuring backward compatibility of the binary library.

### SUMMARY

This binary library supports data parameters of any basic type and parameters of known classes; Moreover, after the binary library is generated, there is no need to modify it, and the binary library also supports the parameters of newly defined classes. To generate the binary library, the source code of the function template or class template does not need to be modified for this purpose.

The present disclosure completely achieved the two requirements that mentioned above:
1. the binary library supports data parameters of any basic type and parameters of known classes that defined before the generation of the binary library; and
2. after the binary library has been generated, to support parameters of new-defined classes, and without requiring modifications to the library, that is, thus ensuring backward compatibility of the binary library. In use, the binary library has the same function with the source code. When applied in use, we can make use of the present disclosure, compile the source code module of the function templates or the class templates containing template parameters into binary libraries, which can not only share the labor achievements of binary library author but also protect their intellectual property.

The specific solution of the present disclosure is: the programmer instantiates the source code module of the function templates or the class templates to a Variant type (the Variant type is designed by the inventor) without modifying source code, and exporting the Variant type as a binary library. When the library is called by a user, as the binary library only includes two types of parameters: 1, Variant type; and 2, other types, include basic data parameters and data parameters of existing classes (existing classes refer to classes defined before creating the binary library), therefore, if it need to transfer parameters of the Variant type to the binary library, only need to convert the basic type data or the object of the new-defined classes (new-defined classes refer to classes defined after the binary library has been generated) into an object of the Variant class, and then transfer it. As for other types of parameters, they can be transferred directly. The result of running the binary library is the same as the result of directly using ordinary data (running the source code module of function templates or class templates containing template parameters). As the Variant type can represent any type of data, therefore the binary library can accept any type of data. Moreover, after the releasing the binary library, the binary library still supports the new-defined classes.

### Key Points of the Present Disclosure

1. Designing a Variant class, the Variant class can represent any type of data. The function templates or class templates are then instantiated as a Variant type, and then the binary library is generated, the Variant class can represent any type of data, that is, the binary library can accept any type of data.
2. The Variant class can accept data from new-defined classes in addition to any basic data type, the Variant class supports the common mathematical and logical operations; however, if Variant class represents the basic data type, mathematical and logical operations are then internally implemented by the Variant class; if the Variant class represents the new-defined classes, then mathematical and logical operations are implemented by the new-defined classes.
3. The Variant class is transparent to the user. Here, “transparent” means that for the authors of the binary library, there is no need to be concerned about the existence of the Variant class; they can continue to write the source code of the library (including function templates or class templates with template parameters) as before. For users of the binary library, since the binary library only accepts two types of parameters: Variant and other types, if Variant type parameters need to be passed to the library, simply to convert the basic type data or new-defined class objects into Variant class objects before passing them. As for other types of parameters, they can be passed directly. The conversion between basic type data or new-defined class object data and Variant class object data can be solved with just a simple assignment statement. The specific conversion method will be explained in the subsequent document.
4. For the author of the binary library, in order to create binary library that can accept any type of parameters (including new-defined classes) from the source code of function templates or the class templates containing template parameters, just instantiate the function templates or the class templates into Variant class type, and then export, and the source code that generate this binary library without any change.
5. All the Variant types (including Variant that represents the new-defined classes) can use the standard templates library (STL).
6. The Variant class is generic, it can apply to any function templates or class templates without modification; users of the present disclosure do not need to design the Variant class, they can directly use the Variant class without modification (as the present disclosure has already realized the design of the Variant class).

To realize the above objective, the present disclosure provides a method for generating a binary library with function templates or class templates that support parameters of any type, including:
S1. designing a Variant class; the S1 is the core content of the present disclosure.
S1 includes the following 6 parts:
S11. designing an union inside the Variant class, named Data, enable it to have the ability to store data of different types; and
S12. adding an enum inside the Variant class, named Type, to represent the data type stored in the Variant, and the Class type represents the data type of new-defined class using the Variant class; and
S13. adding a struct inside the Variant type, named class_data, to store relevant data of new-defined classes, the struct class_data includes an address of the of new-defined class object, and some addresses of related mathematical and logical operation functions; and
S14. within the Variant type, constructing constructors and operator=, to construct the basic type data and the new-defined class object as a Variant object.

For example, operator= is used to assign a Variant object (representing floating-point data), the instruction is: Variant vobj=(float) fdata, and the specific executing process is: firstly, the Variant sets the data type in the enum Type: vobj. Type=Float, and then stores the data at the corresponding position f of the union Data, that is, vobj.data.f=fdata.

If operator= is used to assign a Variant object (representing new-defined object), and then operate according to the following instructions:
Person obj (“ghi”, 12); // constructing the new-defined class Person object: obj; and
Variant vobj=obj; // constructing the Variant object: vobj.

The specific execution process is as follows: firstly, setting the data type in enum type, that is, vobj.type=Class, and then store the address of the new-defined class object in struct class_data, that is, vobj::class_data::ptr_class=& obj.

But there is only one requirement for the new-defined classes: a type must be defined in the new-defined classes. In addition, after the assignment of the Variant object (representing the new-defined class object) is completed, it is necessary to register the arithmetic and logical operation functions supported by the new-defined classes. For example, the following statement:
vobj.set_fun_equ (& the_equ<MY_CLASS>); // registering the new-defined class operator==; and
vobj.set_fun_lt (& the_lt<MY_CLASS>); // registering the new-defined class operator <.

Thus, two logical operations that supported by the new-defined classes are registered: operator== and operator <.

Convention methods for the Variant object and other types of data are summarized below:
1) between base type data and the Variant object:
Variant Object=base type data; // the base type data is converted to Variant object; and
Base type data=Variant object; // the Variant data is converted to the base type data.
2) Between the new-defined class object and the Variant object:
Variant Object=new-defined class object; // the new-defined class object is converted to the Variant object; and
the pointorof the new-defined classes object=Variant object; // the Variant object is converted to a pointer of the new-defined class object.
S15. Setting operation ability, the class provides the following operations:
a, arithmetic operations, including addition, subtraction, multiplication, division, and other operations; and
b, other operations, including trigonometric, logarithmic, and exponential operations; and
c, comparative operation, including operations greater than, less than, and equal to;
d, operation of the new-defined classes, if the Variant type represents the base type data, the operations are provided by the Variant type; and if the Variant type represents the new-defined classes, the operations (including mathematical and logical operations, etc.) are implemented by the new-defined classes. And, if the Variant represents new-defined classes, the new-defined classes need to be registered in a Variant object.

For example:
Variant vobj=obj; // constructing the Variant object, obj is new-defined class object;
vobj.set_fun_equ (& the_equ<MY_CLASS>); // registering the new defined class operator==.

This will register the operator== for the new-defined classes. All the operator== of the Variant object (representing the new-defined classes) are implemented by the operator== Of MY_CLASS (the new-defined classes).
S16. Stream output.

To make the Variant object be like with the basic data type, by the stream output, the present disclosure overload << operator: friend ostream & operator << (ostream & os, const Variant & var). Through the << operator, users can stream Variant object like basic data types and output them to standard output; it can also be output as a string object for further processing of the data.

For example, Variant obj=1.234; cout << obj; and the screen output: 1.234.

Here, the Variant type is generated, and the S1 ends.
S2. designing the function templates or the class templates to be exported;
S3. copying the source code of the Variant class to a current project;
S4. instantiating the function templates or the class templates that designed in S2 into the Variant type, and the source code of the function templates or the class templates that to be exported do not need any modification;
S5. exporting the function templates or the class templates of Variant type as a binary library. In fact, it is to export a common (no template parameters) class or function into a binary library.

Compared with the prior arts, the present invention has the following advantages:
(1) template technology is the most advanced programming technique in the field of C or C++ programming, the source code of the template technology can accept any type of data; since the birth of the template technology, for such program modules, if they are used by other users, the source code must be provided, but this will damage the author's intellectual property rights.

The present disclosure creates a binary library for software modules (containing template parameters), and the library can accept any type of parameters. After the binary library is generated, objects of new-defined classes are still supported by the binary library without any modifications. In this way, this disclosure can effectively protect the rights and interests of library producers while also sharing these software components (including template parameters).
(2) No need to modify the source code. In order to generate a binary library that can accept any data type parameters (including new-defined classes) from the source code module of the function templates or the class templates containing template parameters, firstly, instantiating its template parameters to Variant class type, and then exporting them as the binary library, without making any changes to the source code that generates this binary library.
(3) template technology and STL technology are advanced software technologies that can greatly improve programming efficiency and reliability. However, in the past, if software modules calls these advanced technologies with template parameters, they could not create the binary library that could accept any type of parameters. Now, with the present disclosure, these advanced technologies can also be called when creating the binary library that can accept any type of parameters. So, the technical advantages brought by template technology and STL technology is also applicable when creating the binary library, and greatly improving programming efficiency and reliability.
(4) Prior to the present disclosure, in the C and C++ software industries, software modules utilizing advanced technologies of the template technology and STL, and must be the source code. But as long as the source code is provided, it means that the author has given up the right to profit, which seriously limits the author's enthusiasm.

Because the present disclosure eliminates the obstacles that hinder the application of the aforementioned advanced technologies, it will effectively stimulate the enthusiasm of enterprises to use the aforementioned advanced technologies to produce binary library, and promote the development of the software industry worldwide.

### BRIEF DESCRIPTION OF THE DRAWINGS

FIG. 1 is a flow chart of a method for generating a binary library with function templates or class templates that support parameters of any type according to an embodiment of the present disclosure.

FIG. 2 is a detail flow chart of the generating method of the binary library of the function templates or the class templates able to apply in any type of parameters according to an embodiment of the present disclosure.

FIG. 3 is a relationship diagram between operators, related functions, and registration functions of Variant and new-defined classes.

FIG. 4 is another detail flow chart of the generating method of the binary library of the function templates or the class templates able to apply in any type of parameters according to an embodiment of the present disclosure.

FIG. 5 is a structure diagram an equipment for generating a binary library with function templates or class templates that support parameters of any type.

### DETAILED DESCRIPTION OF THE EMBODIMENTS

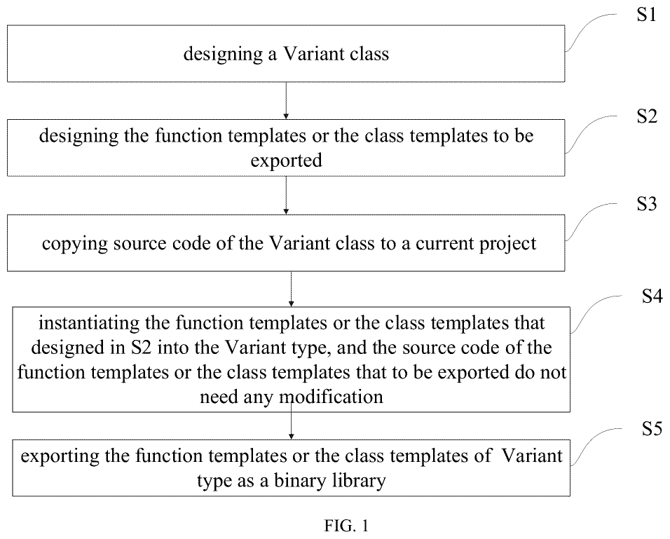

As shown in FIG. 1, the embodiment of the present disclosure includes 5 steps:
S1. Designing a Variant class.

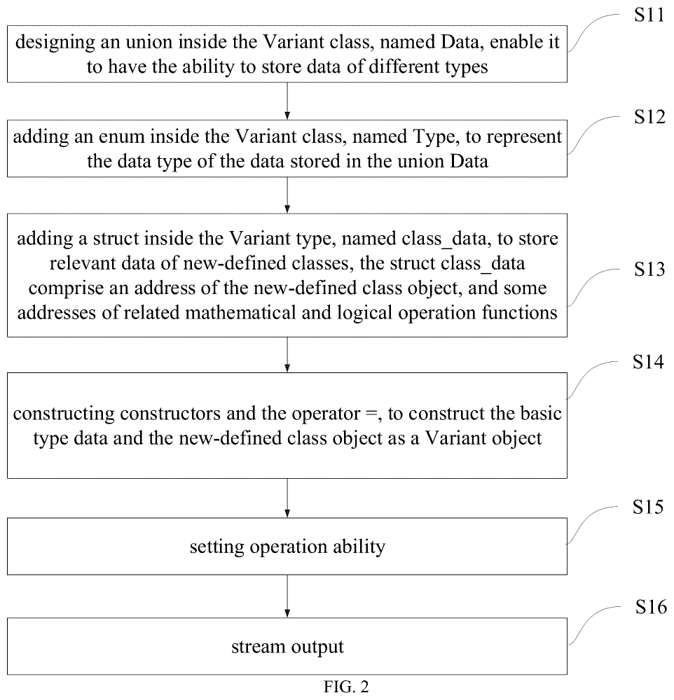

As shown in FIG. 2, S1 includes the following 7 sub steps.
S11. Designing an union inside the Variant class, named Data, enable it to have the ability to store data of different types. The statements are as followed:

```
union Data
            {
    int i;
      long l;
            float f;
            .......;
        };
  Data data.
```

S12. Adding an enum inside the Variant class, named Type, to represent the data type of the data stored in the union Data. The statements are as followed:

```
enum Type
{
      Invalid,
      Int,
      Long,
      Float,
      String,
    Class, // the new-defined classes
  ......
  }
```

S13. Adding a struct inside the Variant type, named class_data, to store relevant data of new-defined classes, the struct class_data include an address of the new-defined class object, and some addresses of related mathematical and logical operation functions.

```
struct class_data_tag
  {
      unsigned char * ptr_class; // address of the new-defined class object
      relative_fun_prt ptr_equ; // address of the operator ==
      relative_fun_prt ptr_gt; // address of the operator >
      relative_fun_prt ptr_lt; // address of the operator <
  ......
    }
```

S14. Designing constructors and the operator=, to construct the basic type data and the new-defined class object as a Variant object. For example, constructing the Variant object representing a float type data: Variant (float f): Variant (float f): type (Float), {data.f=f;}.
S15. Setting operation ability, the class provides the follow operations:
a. arithmetic operations, including addition, subtraction, multiplication, division, and other operations.

The following is part of the addition operation code:
templates <typename T> friend Variant operator+(const T& v1, const Variant & v2) {return Variant (v1). add (v2);}
b. other operations, including trigonometric, logarithmic, and exponential operations.

The following code is function prototype of the trigonometric, the logarithmic, and the exponential operations:
friend double sin (Variant & vr); and
friend double log (Variant & x).
c. comparative operation, including operations greater than, less than, and equal to.

The following is part code of operator==:

```
templates < typename T> friend bool operator == (const T& v1, const Variant & v2)
{
  if (v2. type) == Variant::Class) return (v2 == v1);
  else return Variant (v1).equ (Variant (v2)); }
```

d. operation of the new-defined classes. If the Variant type represents the base type data, the operations are provided by the Variant type; and if the Variant type represents the new-defined classes, the operations (including mathematical and logical operations, etc.) are implemented by the new-defined classes. The following focuses on introducing its implementation principle. It is implemented through the class_data within the Variant class and the related functions outside the Variant class, the related functions register various operators of the new-defined class into class_data.

In order to make the operations of the binary library to be executed by the new-defined classes which is outside, binary library users need to register the operators of the new-defined classes in the binary library. Registration requires two steps:
1) registering the operators of the new-defined classes in the relevant functions;
2) registering the related functions to the binary library.

TABLE 1
Functions to be called when registering operators of
the new-defined classes

| operators for | related functions | registration functions |
|---|---|---|
| the new- | (on the | (Variant |
| defined classes | user side) | member function) |
| operator < | the_lt | set_fun_lt |
| operator > | the_gt | set_fun_gt |
| operator == | the_equ | set_fun_equ |
| other operators | . . . | . . . |

Table 1 provides the functions that need to be called when registering the operators.

For example, if we want to register the operator < for the new-defined class Person, firstly, the operator < should be defined inside Person. There are two statements: bool operator < (const Person & v) and bool operator <(const int & var)

And then, follow the S15, according to Table 1, the related function of the operator < is the_lt, so the operator < of Person needs to be registered in the function the_lt. The following is partial code of the function the_lt:

```
templates < type name T> bool the_lt (unsigned char * v1,
unsigned char * v2, const char* t1, const char* t2)
{
if ((string (t1) == self_class) && (string (t2) == self_class))
  {
    T* pv1 = (T*)v1; T* pv2 = (T*)v2;
    return (*pv1)<(*pv2);
  }
else if ((string(t1) == self_class) && (is_integer<compile> (t2)))
  { ..... }
  else
  {
  cout << “Not Supported” << string(t1) << “==” << t2 << “ ”.
  return 0;
  }
```

The relative of functions like the_lt are program frameworks that are relatively comprehensive. In general, the binary library users only need to clip the existing code without extensive programming, that is, deleting unsupported operations and leaving the supported ones. In case of special circumstances, if this existing code cannot meet the requirements, users can also write their own judgment branch code.

As the operator <inside the Person only support two operation of Person<Person and Person<int, so the_lt only remains two judgment branches:
Person<Person, if ((string (t1)==self_class) && (string (t2)==self_class)); and
Person<int, if ((string(t1)==self_class) && (is_integer (t2))).

And then follow S15 to register the related function the_lt, the example code is as follows:
Person obj; Variant vobj=obj;
// according to table 1, the registration function of the_lt is set_fun_lt;
vobj.set_fun_lt (& the_lt<Person>).

In this way, for the Variant object Vobj (representing the new-defined class Person), when performing Vobj<Vobj and Vobj<int, the actual operations are the operator <(const Person & v) and operator <(const int & var) operations provided by Person, rather than operations within the Variant object. The reasons for this will be analyzed later.
S16. Stream output.

To make the Variant object be like with the basic data type, the operator << is also supported. For the right operand of the overload operator <<must be the Variant object that represents the basic data type, otherwise an error message will be given. The function prototype is as follows:
friend ostream & operator <<(ostream & os, const Variant & var)

Through the operator <<users can stream Variant object like basic data types and
output them to standard output; it can also be output as a string object for further processing of the data.

In addition, introducing some other code related to the Variant class (some of which do not belong to the Variant class).
typedef bool (*relative_fun_prt) (unsigned char *, unsigned char *,
const char *, const char *) \textcircled{1}
templates <type name T>bool the_lt (unsigned char* v1, unsigned char* v2, const char* t1, const char* t2) \textcircled{2}
\textcircled{1} is a function type definition, which is used in two places. One is in the Variant:: struct class_data, and the other is on the user side, where it represents functions related to (binary_functions of the new-defined classes).

In the Variant class::struct class_data, there are multiple operator function definitions, as detailed below:

struct class_data
{
unsigned char * ptr_class; // address of the new-defined class object
relative_fun_prt ptr_equ; // address of the relative operator ==
relative_fun_prt ptr_gt; // address of the relative operator >
relative_fun_prt ptr_lt; // address of the relative operator <
......
}

On the user side, as shown in Table 1, there can be multiple related functions, and Equation \textcircled{2} is just one of them; all types of them are defined by Equation \textcircled{1} (i.e., relative_fun_prt).

To have the binary library's operations executed by external new-defined classes, as mentioned in the preceding text: S15. setting operation ability, Operations->d->S2, it is necessary to register the related functions in the binary library using registration functions. Registration functions are member functions of the Variant class. Here, one of them is shown to illustrate its principle.
void set_fun_lt (relative_fun_prt pv) {class_data. ptr_equ-pv;}.

On the user side, by calling set_fun_lt(&the_lt<MY_CLASS>), the value of class_data:: ptr_lt will be assigned using Equation \textcircled{2}.

Below is the code for one of the two operator<functions within the Variant:

```
  if((v1.type( ) == Variant::Class) && (v2.type( ) == Variant::Class))
  {
  return (v1.class_data.ptr_lt)
    (v1.class_data.ptr_class,  v2.class_data.ptr_class,  “Variant::Class”,
“Variant::Class”);
  }
  // other branches are omitted here.
  else return Variant(v1).lt (Variant(v2)); // both v1 and v2 are not the new-defined
classes.
  }
```

It can be seen that if both v1 and v2 are not Variant objects representing new defined class, the v1<v2 operation is executed by the internal code of the Variant class. If both v1 and v2 are Variant objects representing new defined class (the type is Variant::Class), the v1<v2 operation calls the class_data::ptr_lt function, which is the function on the binary library's user side, i.e., Equation \textcircled{2}, and Equation \textcircled{2} at least calls the operator<defined in the new defined classes.

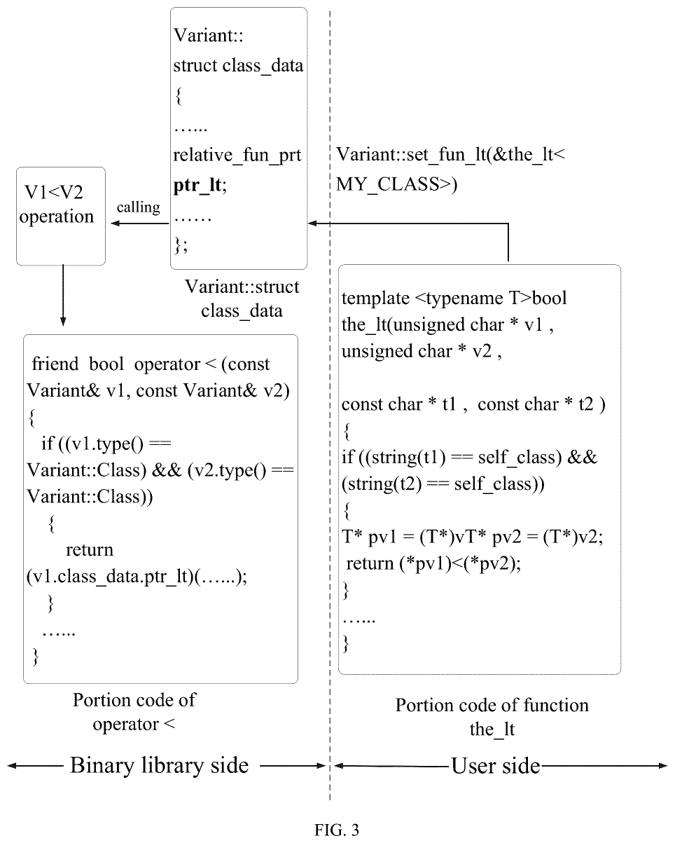

Please refer to FIG. 3, which details the relationships between the operators in Variant, the operators in the new-defined classes, the related functions (on the user side), and the registration functions (member functions of Variant).

Thus, the S1, design of the Variant class, is end.
S2, Designing and exporting binary library.

This embodiment will design and export class templates Ctest_variant and function templates Test_Variant_Fun.

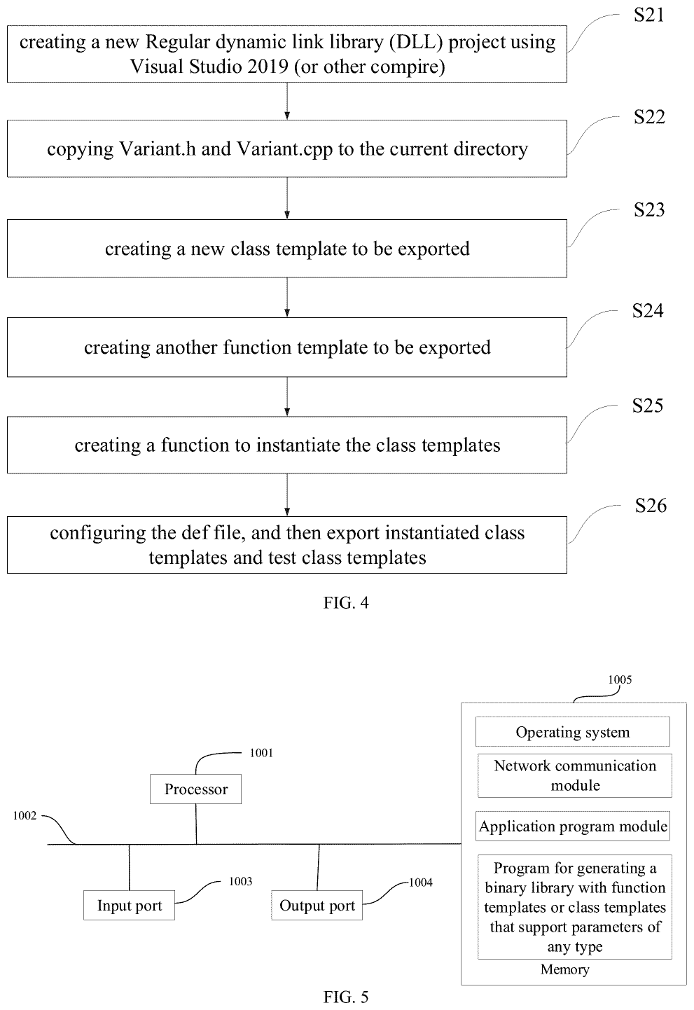

Please refers to FIG. 4, S2 includes the following six sub-steps:
S21. Creating a new Regular dynamic link library (DLL) project using Visual Studio 2019 or other compire; and
S22. Copying Variant.h and Variant.cpp to the current directory.
S23. Creating a new class template to be exported, with the following source code:

```
templates <typename T>class Ctest_variant
{
public:
  Ctest_variant( ) {num = 0;prt = 0;}
  Ctest_variant( T * v, int n );
  virtual ~Ctest_variant( );
  virtual T computer(T v1, T v2, int op);
  virtual void Variant_use(T * p, int n, T * pout);
private:
    T * prt;
    int num;
}.
```

The definitions of the member functions are as follows:

```
templates <typename T> // this function will test the use of STL.
void Ctest_variant<T>::Variant_use(T * p, int n, T * pout)
{
  /*
Parameter Descriptions:
p: address of the first element of the array of type T; and
n: number of elements in the array of type T; and
pout [0] out: position of elements greater than pout[2]; and
pout[1] out: count of elements greater than pout[3]; and
pout[4] out: minimum value in the p array; and
pout[5] out: maximum value in the p array; and
pout[2] in: search for position of elements greater than pout[2]; and
pout[3] in: count of elements greater than pout[3]; and
std::vector<Variant > vr(p, p + n);
  sort(vr.begin( ), vr.end( )); // Sort the array
  pout[4] = * vr.begin( );// Minimum value
  std::priority_queue<Variant> pr(p, p + n);
  pout[5] = pr.top( );// Maximum value
  const T& paral = pout[2];
  // find the position of elements greater than pout[2]
  auto it = find_if(vr.begin( ), vr.end( ), [&para1](T v) { return (v > para1); });
  pout[0] = it − vr.begin( );
  const T& para2 = pout[3];
  // Count the number of elements greater than pout[3]
  pout[1] = count_if(vr.begin( ), vr.end( ), [&para2](Tv) { return (v > para2); });
  // Modify the original array using the sorted array
  inti = 0;
  for_each(vr.begin( ), vr.end( ), [&i, &p](Tv) { p[i] = v; i++; });
}
templates <typename T> // this function will test various mathematical operations
T Ctest_variant<T>::computer(Tv1, Tv2, int op)
{
    T vret;
  switch (op)
  {
  case 0:
        vret = v1 + v2;
        break;
  case 1:
        vret = v1 - v2;
        break;
      ..._{..}
  }
    return vret;
}
```

S24. Creating another function template to be exported, with the source code as follows:

```
templates<typename T> void Test_Variant_Use(T * p, int n, T * pout)
{
/*
parameter description:
p: the address of the first element of the array of type T;
n: the number of elements in the array of type T
pout[0] out :the position of elements greater than pout[2]
pout[1] out: the count of elements greater than pout[3]
pout[5] out: the maximum value in the p array
pout[2] in: the position of elements greater than pout[2]
pout[3] in: the count of elements greater than pout[3]
*/
  std::vector<Variant > vr(p, p+n);
    const T & paral = pout[2];
    // the following line will search for the position of elements greater than pout[2]
    auto it = find_if(vr.begin( ), vr.end( ), [&para1](Tv) { return (v > para1); });
    pout[0] = it − vr.begin( );
    int para2 = pout[3];
    // the following line will sort the array
    sort(vr.begin( ), vr.end( ));
      // the following line will count the number of elements greater than pout[3]
    pout[1] = count_if(vr.begin( ), vr.end( ), [&para2](Tv) { return (v > para2); });
    inti = 0;
    // the following line will write the sorted data back to the original array
    for_each(vr.begin( ), vr.end( ), [&i, &p](Tv) { p[i] = v; i++; });
}
```

S25. Creating a function to instantiate the class templates as follows::

```
Ctest_variant<Variant>.
  Ctest_variant<Variant> * GetTheCon(void)
  return new Ctest_variant<Variant>; }
```

Creating a function to instantiate the function templates as follows::

```
Test_Variant_Fun<Variant>.
  void test_variant_fun (Variant * p, int n, Variant * pout)
  return Test_Variant_Fun(p, n, pout); }
```

S26. Configuring the def file and exporting the GetTheCon and test_fun_variant.

This will generate two files: Variant_use.lib and Variant_use.dll.

At this point, S2 of designing and exporting the binary library is complete.
S3: Testing the binary library

This step primarily involves testing the binary library generated in S2.

It includes the following three sub-steps:
S31. creating a new console project (in this example, the VC version is VS2015); and
S32. copying the two binary library files Variant_use.lib and Variant_use.dll, along with the two source files Variant.h and Variant.cpp into the current directory; and
S33. testing the templates class Ctest_variant<Variant>, and the complete test code is as follows:

```
#include “Variant.h”
#include “Ctest_variant.h”
#include “common.h”
#pragma comment(lib,“Variant_use.lib”)
extern “C” Ctest_variant<Variant> * GetTheCon(void);
extern “C” void test_fun_variant(Variant * p, int n, Variant * pout);
// the new-defined classes are used to test the binary library.
class Person
{
public:
  typedef bool type;//using type = bool;
  Person(string name, int grade)
  {
    this->m_Name = name;
    this->m_Grade = grade;
  }
  string m_Name;
  int m_Grade;
  bool operator < (const Person& v)const
  {
    if (m_Grade == v.m_Grade)
      return m_Name < v.m_Name;
    else return m_Grade < v.m_Grade;
  }
  bool operator > (const Person& v)const
  {
    if (m_Grade == v.m_Grade)
      return m_Name > v.m_Name;
    else return m_Grade > v.m_Grade;
  }
  bool operator > (const int & v)const
  {
    return m_Grade > v;
  }
  bool operator < (const int &var)const
  {
    return m_Grade < var;
  }
  bool operator== (const Person& v)const
  {
    cout << “op == (const Person&) in myself class -> ”;
    return ((m_Name == v.m_Name) && (m_Grade == v.m_Grade));
  }
  bool operator == (const int & vr)const
  {
    cout << “op == (const int &) in myself class -> ”;
    return (m_Grade == vr);
  }
  friend ostream& operator << (ostream& os, const Person& var)
  {
    std::cout << “m Name = ” << var.m_Name;
    std::cout << “ m_Age = ” << var.m_Grade ;
    return os;
  }
};
/*
```

The following is the user-trimmed function the_lt, which is used to register the operator< for custom classes. Since there are only two types of operator< for the new-defined classes (Person<Person and Person<int), the_lt has only two branches remaining.

```
  */
  template <typename T>bool the_lt(unsigned char* v1, unsigned char* v2, const char*
t1, const char* t2)
  {
    // new-defined classes < new-defined classes
    if ((string(t1) == self_class) && (string(t2) == self_class))
    {
        T* pv1 = (T*)v1; T* pv2 = (T*)v2;
      // bool operator < (const Person&)const
        return (*pv1)<(*pv2) (inside the new-defined classes);
    }
    // new-defined class < int inside the new-defined class
    else if ((string(t1) == self_class) && (is_integer<compile>(t2)))
    {
        T* pv1 = (T*)v1; long var;
        stringstream ss;
        ss << v2; ss >> var;
        // bool operator < (const int &) const inside the new-defined class
        return ( (*pv1) < var );
    }
    else { cout << “not support” << string(t1) << “==” << t2 << “ ”.
      return 0; }
  }
  // The following is the user-trimmed function the_gt, which is used to register the
operator> for the new-defined class.
  template <typename T>bool the_gt(unsigned char* v1, unsigned char* v2, const char*
t1, const char* t2) {omitted here}
  // the following is the user-trimmed function “the_equ”, used to register the
‘operator==’ for new-defined classes.
template <typename T>bool the_equ(unsigned char* v1, unsigned char* v2, const
char* t1, const char* t2) {omitted here}
  #define compile msvc
  #define MY_CLASS Person
  int main( )
  {
    cout << “testing Ctest_variant with the Variant class (basic data types) begins: \n”;
    const int sz2 = 6; Variant ret[8];
    Variant data2[sz2] = { 7, 6, 7.34 , (double)5.01 , 2 ,1 };
    cout << “original data: \n”;
    copy(data2, data2 + sz2, ostream_iterator<Variant >(cout, “ ”));
  cout << endl;
    Ctest_variant<Variant> * pv = GetTheCon( );
  /* parameters for the member function of the template class Ctest_variant<Variant>:
  Variant_useSTL (Variant * p, int n, Variant *pout)
  p: address of the first element in the T-type array;
  n: Number of elements in the T-type array
  pout[0] out: Position of the element greater than pout[2] ;
  pout[1] out: Number of elements greater than pout[3]
  pout[4] out: Minimum value in the p array ;
  pout[5] out: Maximum value in the p array
  pout[2] in: Position of the element greater than pout[2] ;
  pout[3] in: Number of elements greater than pout[3]
  */
      ret[2] = 7; // search for the position of the element greater than ret[2]
  ret[3] = 5; // Count the number of elements greater than ret[3]
      pv->Variant_useSTL(data2, sz2, ret);// Call the member function of the
Ctest_variant<Variant>
      cout << “sorted data(class Ctest_varian): \n”;
      copy(data2, data2 + sz2, ostream_iterator<Variant >(cout, “ ”));
      cout << endl;
  cout << “min=” << ret[4] <<“  ”; cout<< “max=” << ret[5] << “ ” << endl;
  cout << “position greater than” << ret[2] << “= ” << ret[0] << “ ”;
      cout << “number of elements greater than ” << ret[3] << “= ” << ret[1] << endl;
      cout << “testing mathematical operations for the Variant class: \n”;
      Variant d1 = 3.1416; Variant d2 = 10; int i;
      string op[9] = {“+”,“−”,“*”,“ /”, “pow” , “sin” , “asin” , “log” , “exp” };
      for (i = 0; i <5; i++)
      {
        cout << d1 << op[i] << d2 << “ = ”;
        cout<<fixed<<pv->computer(d1, d2, i)<<endl;
      }
      for (; i <6; i++)
      {
        cout <<“10000*”<<op[i] << d1 << “ = ”;
        cout << fixed << 10000* pv->computer(d1, d2, i) << endl;
      }
    cout << “testing Ctest_variant with the Variant class (basic data types) ends \n”;
    cout << “testing Ctest_variant with the Variant class (representing the new-defined
class Person) begins: \n”;
    MY_CLASS obj1(“ghi”, 12); MY_CLASS obj2(“abc”, 11);
  MY_CLASS obj3(“def”, 13); MY_CLASS obj4(“def”, 14);
    Variant ot1 = obj1;
    ot1.set_fun_equ(&the_equ<MY_CLASS>);
ot1.set_fun_gt(&the_gt<MY_CLASS>); ot1.set_fun_lt(&the_lt<MY_CLASS>);
  code for ot2, ot3, and ot4 omitted here
      const int sz1 = 4;
      Variant data3[sz1] = { ot1 ,ot2,ot3,ot4 };
      cout << “original data: \n”;
  MY_CLASS data2U[sz1] = {
  *(MY_CLASS*)(data3[0]) ,*(MY_CLASS*)(data3[1]),
      *(MY_CLASS*)(data3[2]),*(MY_CLASS*)(data3[3]) };
      copy(data2U, data2U + sz1, ostream_iterator< MY_CLASS>(cout, “ \n”));
      // prepare parameters for calling the (binary library) template function
      ret[2] = data3[0];// position of element greater than ret[2]
      ret[3] = 11;  // number of elements greater than ret[3]
      pv->Variant_useSTL(data3, sz1, ret);//call the member function of the
Ctest_variant<Variant>
      cout << “minimum value is” << *(MY_CLASS*)ret[4] << endl;
      cout << “maxmum value is” << *(MY_CLASS*)ret[5] << endl;
      cout << “position greater than object” << *(MY_CLASS*)(ret[2]) << “= ” << ret[0]
<< endl;
      cout << “number of elements greater than” << ret[3] << “= ” << ret[1] << endl;
      cout << “testing Ctest_variant with the Variant class (representing the new-defined
class Person) ends \n”;
    cout << “sorted data(class Ctest_varian): \n”;
    MY_CLASS dataU3 [sz1]={
  *(MY_CLASS*)(data3[0]), *(MY_CLASS*)(data3[1]) ,
  *(MY_CLASS*)(data3[2]), *(MY_CLASS*)(data3[3]) };
      copy(dataU3, dataU3+ sz1, ostream_iterator< MY_CLASS>(cout, “ \n”));
  return 0;
  }
```

Testing the output of the template class Ctest_variant, as shown in test results of S3. Thus, S3 of testing the binary library end.
S4. Test results and program analysis:

The member function Ctest_variant <T>::Variant_use primarily demonstrates the use of various STL functions, while the member function Ctest_variant<T>::computer mainly shows mathematical operations on Variant type data.

In the binary library, one output by the binary library is a class, and the other is a function. The class is Ctest_variant <Variant>, which is the instantiation of the Ctest_variant <T> with Variant type. The output function is Test_Variant_Fun <Variant> (Variant*p, int n, Variant*pout), which is the instantiation of the function template Test_Variant_Fun <T> with Variant type.

We tested the class Ctest_variant<Variant> output by the binary library in a console program. For brevity, the analysis of the function template Test_Variant_Fun is omitted here. The main testing tasks are: testing the operation of the binary library with Variant objects (representing basic type data) as parameters, and testing the operation of the binary library with Variant objects (representing the new-defined class Person) as parameters.
a. For the first case, where Variant objects (representing basic type data) are used as parameters to the binary library, the test examines whether Variant can represent various basic type data and whether the results are correct.

From the statement Variant data2 [sz2]={7, 6, 7.34, (double)5.01, 2, 1}, it is evident that Variant can indeed represent int, float, double, etc. The mathematical operations also yielded correct results. For instance: 3.1416+10=13.1416 and sin(3.1416)=−7.3*10⁻⁶.

In terms of using STL with the binary library, it correctly performed the following tasks on arrays of Variant objects: sorting, finding the maximum value, finding the minimum value, and counting elements that meet certain criteria. In summary, using Variant objects (representing basic type data) as parameters to the binary library consistently produced correct results.
b. Testing for the second case. This involves testing the behavior of a binary library when using Variant objects (representing the new-defined class Person) as parameters.

The objective of this test is to determine whether the binary library supports the new-defined class Person. The criterion for support is: if the results from the binary library operations match those obtained from directly using Person objects, it indicates that the binary library supports the new-defined class. For example, if the original data is an array of Person objects, and the binary library can sort it; by contrast, you sort directly using Person objects (not use the binary library), if the results are identical, it proves that the binary library supports sorting operations on Person objects (operator <). Other operations on Person objects are validated similarly.

In practice, we use the Variant class to transfer Person objects to functions in the binary library. Since the parameters transferred to the binary library functions are Variant objects (representing Person objects), the process is as follows: if the results from the binary library when using Variant objects (representing Person objects) as parameters match the results from direct operations on Person objects, it proves that the binary library supports the new-defined class; otherwise, it indicates that the binary library does not support the new-defined class.

The binary library was tasked with the following operations on an array of Variant objects (representing Person class objects): sorting, finding the maximum value, finding the minimum value, and counting elements (that meet a certain condition). Based on the results shown below, when the parameters passed to the binary library functions are Variant objects (representing Person class objects), the binary library's results indeed match those obtained from directly using Person objects.

The following are test results of S3:
Testing Ctest_variant with Variant class (basic data types) begins:
Original data: 7.34 5.0126
Sorted data (class Ctest_variant):
125.01 677.34
min=1 max=7.34
Position greater than 7: 5 Number greater than 5: 4
The following tests the mathematical operations of the Variant class:

$$3.14 16 + 10 = 13.1416$$

$$3.1416 - 10 = - 6.8584$$

$$3.1416 * 10 = 31.416$$

$$3.1416 / 10 = 0.31416$$

$$3.1416 \hat{} 10 = 93650.2$$

$$10000 * sin ( 3.1416 ) = - 0.0734641$$

Testing Ctest_variant with Variant class (basic data types) ends.
Testing Ctest_variant with Variant class (representing the new-defined class Person) begins:
Original data:
m_Name=ghi m_Age=12
m_Name=abc m_Age=11
m_Name=def m_Age=13
m_Name=def m_Age=14
Minimum value is m_Name=abc m_Age=11
Maximum value is m_Name=def m_Age=14
Position greater than object m_Name=ghi m_Age=12:2
Number greater than 11:3
Sorted data (class Ctest_variant):
m_Name=abc m_Age=11
m_Name=ghi m_Age=12
m_Name=def m_Age=13
m_Name=def m_Age=14

Testing Ctest_variant with Variant class (representing the new-defined class Person) ends. Press any key to continue . . . .

Since both tasks in the test produced correct results, it demonstrates that the binary library not only supports basic data types but also supports objects of new-defined classes. This confirms that the invention achieves its intended purpose.

The method for generating a binary library with function templates or class templates that support parameters of any type is processed by an equipment for generating a binary library with function templates or class templates that support parameters of any type.

As shown in FIG. 5, the equipment generating the binary library with the function templates or the class templates that support parameters of any type includes: a processor 1001 (such as Central Processing Unit, CPU), a communication bus 1002, an input port 1003, an output port 1004, and a memory 1005. Among them, the communication bus 1002 is used to achieve connection communication between these components; the input port 1003 is used for data input; and the output port 1004 is used for data output, and the memory 1005 can be high-speed RAM memory or non-volatile memory, such as disk memory, non-transitory computer-readable storage medium. Optionally, memory 1005 is a storage device independent of the aforementioned processor 1001.

The memory 1005, as a non-volatile readable storage medium, may include an operating system, network communication module, application program module, and a program for generating a binary library with function templates or class templates that support parameters of any type. The network communication module is mainly used to connect to servers and communicate data with them; And processor 1001 is used to call the program to process the method stored in memory 1005, and execute all steps of the method for predicting thermal runaway in a lithium battery based on capacitive reactance analysis mentioned above.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A method for generating a binary library with function templates or class templates that support parameters of any type, wherein, comprising following steps of:
S1. designing a Variant class;
wherein, the Variant class comprises the following seven features:
(1) the Variant class represents data of any type, comprising basic types from C and C plus plus (C++), and new-defined class objects;
(2) the Variant class supports mathematical and logical operations;
(3) objects of the Variant class are compatible with standard templates library (STL);
(4) the Variant class has the ability to represent the new-defined class objects, and after the binary library is generated with Variant class types as parameters, no modifications to the binary library are needed, and the Variant class also supports new-defined classes (new-defined classes:
classes defined after the binary library is generated);
(5) to mark the new-defined classes, a specific data type name must be defined within the class; and actual data type represented by the specific data type name is inconsequential, but the specific data type name must be unique;
(6) the conversion between any type of data (including new-defined objects) and Variant objects can be achieved with a single assignment statement;
(7) the Variant class is generic and is used with any function templates or class templates without modification; users of the present disclosure do not need to design the Variant class themselves, as the designing of the Variant class has already been completed;
S2. designing the function templates or the class templates to be exported;
S3. copying source code of the Variant class to a current project;
S4. instantiating the function templates or the class templates that designed in S2 into the Variant type, and the source code of the function templates or the class templates that to be exported do not need any modification;
S5. exporting the function templates or the class templates of Variant type as a binary library.

2. The method for generating the binary library with the function templates or the class templates that support parameters of any type according claim 1, wherein, the S1 comprising:
S11. designing an union inside the Variant class, named Data, enable it to have the ability to store data of different types;
S12. adding an enum inside the Variant class, named Type, to represent the data type of the data stored in the union Data;
S13. adding a struct inside the Variant type, named class_data, to store relevant data of new-defined classes, the struct class_data comprise an address of the new-defined class object, and some addresses of related mathematical and logical operation functions;
S14. constructing constructors and the operator=, to construct the basic type data and the new-defined class object as a Variant object;
S15. setting operation ability;
S16. stream output.

3. The method for generating the binary library with the function templates or the class templates that support parameters of any type according claim 1, wherein, the S2 comprising:
S21. creating a new Regular dynamic link library (DLL) project using Visual Studio 2019 (or other compire);
S22. copying Variant.h and Variant.cpp to the current directory;
S23. creating a new class template to be exported;
S24. creating another function template to be exported;
S25. creating a function to instantiate the class templates;
S26. configuring the def file, and then export instantiated class templates and test class templates.

4. The method for generating the binary library with the function templates or the class templates that support parameters of any type according claim 1, wherein, after S5, the method also comprise:
passing the required parameters to the binary library and call the binary library to execute the usage process;
wherein, comprising the following two cases:
I. for the basic type data and existing custom class objects (existing custom classes: those defined before the binary library generation), passing them directly to the binary library; and
II. for the Variant type data, which also falls into two cases:
i. if the Variant type data represents the basic type data, converting the basic type data to a Variant object, and then passing the Variant object to the binary library; and
ii. if the Variant type data represent objects of the new-defined class, follow these three steps:
(i) converting the new-defined class object to a Variant object; and
(ii) registering the operators of the new-defined class in the binary library; and
(iii) passing the Variant object as an actual parameter to the binary library.
